(19) United States
(12) Patent Application Publication
(10) Pub. No.: US 2026/0050944 A1
(43) Pub. Date: Feb. 19, 2026

(54) SYSTEMS AND METHODS FOR IDENTIFYING ENHANCED INTERPRETATION OF DATA

(71) Applicant: MASTERCARD INTERNATIONAL INCORPORATED, PURCHASE, NY (US)

(72) Inventors: Jenna Khan, Salisbury, MD (US); Praveen Punia, Chandrapur (IN); Shahreen Hossain, New York, NY (US); Steve Roth, Wayne, NJ (US)

(21) Appl. No.: 18/809,112

(22) Filed: Aug. 19, 2024

(51) Int. Cl. G06Q 30/0226

(52) U.S. Cl. CPC G06Q 30/0233; G06Q 30/0232

(57) ABSTRACT

Systems and methods are provided for identifying enhanced interpretation of certain data. One example computer-implemented method includes, in response to a request, retrieving, from a database, reward redemption data representative of redemption of rewards for travel purchases and limited to a scope, as defined in the request, and calculating a reward redemption divisor (RRD) based thereon. The computer-implemented method also includes retrieving at least one industry metric, calculating a RRD-based metric based on the RRD and the retrieved at least one industry metric, and then presenting the RRD-based metric in response to the request.

### FIELD

The present disclosure generally relates to systems and methods for use in identifying enhanced interpretation of data, and in particular, enhanced interpretation of data specific to redemptions for airline travel.

### BACKGROUND

This section provides background information related to the present disclosure which is not necessarily prior art.

Data analytics are used in connection with operational decisions and efficiencies in a number of different industries. The airline industry, for example, relies on common data metrics to make decisions, based on analytics, related to routes, scheduling, discounts, etc. One example common data metric is available seat miles (ASM), which is the number of available seats for a given plane multiplied by the number of miles the plane is expected to fly for the given flight. The ASM may be combined with a cost metric to provide cost per available seat mile (CASM), or a CASM metric. Other metrics may include, for example, revenue per passenger mile (RPM), load factors, yield, ancillary revenue per passenger, fuel efficiency, rout profitability, etc. These metrics are known to be leveraged, through analytics, and relied on by the airlines, in informing decisions related to operations.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in identifying enhanced interpretation of certain data;

FIG. 2 is a block diagram of an example computing device that may be used in the system of FIG. 1; and

FIG. 3 is an example method for identifying enhanced interpretation of certain data that may be implemented in the system of FIG. 1.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

The airline industry relies on certain metrics, and analytics related to those metrics, to make business decisions. The metrics, however, are limited in what is captured, and what is not captured thereby. For example, the metrics are not combined with certain purchase data (e.g., payment account purchasing, rewards redemptions, etc.), which generally limits the informative nature of the metrics. In this way, the absence of data, which is informative of customer purchase planning, route selection, schedule preferences, etc., limits performance of the analytics reliant on the metrics.

Uniquely, the systems and methods herein provide for identifying enhanced interpretation of certain data, and in particular, use of redemption data in general and/or as a time series for enhanced interpretation of airline metrics.

In particular, in example embodiments, the systems and methods define a metric herein as a reward redemption divisor (broadly, a divisor), which is calculated as a sum of specific payment account related data, for example, reward redemptions, money spent, etc., per airline (or per merchant in general), per issuer, per account, etc., over time (e.g., quarterly, annually, etc.). The reward redemption divisor is then employed, in a new way, in different combinations with airline metrics (broadly, industry metrics) to define new metrics (e.g., as a combination of the metrics and the payment account related data, etc.). The new metrics are then used to determine new insights into airline travel, which are used in decision making related to the airlines. In this way, the new metrics may be used, by travel providers, or others, to gain further insights into purchase behaviors, whereby improved objectivity, granularity for decisions related to routes, scheduling, discounts, etc., is/are gained through unique, limited operations to achieve an improved technological result in conventional industry practice.

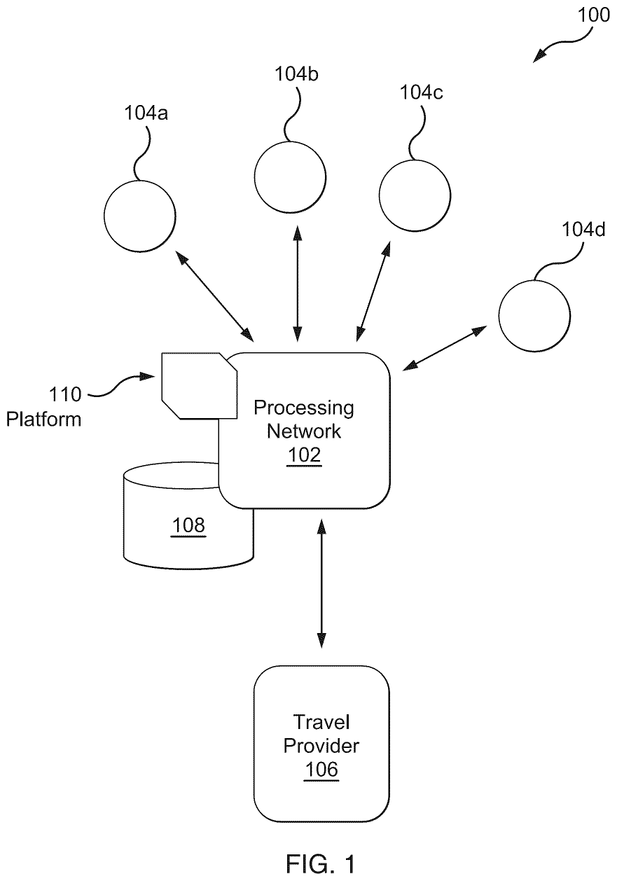

FIG. 1 illustrates an example system 100, in which one or more aspects of the present disclosure may be implemented. Although the system 100 is presented in one arrangement, other embodiments may include systems arranged otherwise depending, for example, on travel options, data privacy rules and regulations, etc.

The system 100 generally includes a processing network 102, multiple financial institutions 104a-d, and a travel provider 106, each coupled in communication, via one or more networks. The networks are represented by the arrowed lines in FIG. 1, and may each include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

In this embodiment, the processing network 102 is configured to facilitate payment transactions between the financial institutions 104a-d.

In particular, the institutions 104 a-d are configured to issue accounts (e.g., credit accounts, debit accounts, prepaid accounts, etc.) to persons, business, agencies, partnerships, or other users, which may then be source accounts or destination accounts in connection with the payment transactions. The processing network 102 is configured to coordinate messaging between the institutions 104 a-d to provide for authorization, clearing and settlement of the transactions.

In one example, the institution 104a is configured to issue an account to a person (not shown), and the institution 104b is configured to issue an account to a business (not shown). When the person initiates a payment transaction at the business, an authorization message is directed to the institution 104b (as an acquirer), which is configured to forward the message to the processing network 102. The processing network 102 is configured to then pass the authorization message to the institution 104a (as an issuer). The institution 104a is configured to approve or decline the transactions, whereby the institution 104a is configured to compile and transmit an authorization response back to the processing network 102, which is configured to pass the authorization response to the institution 104b. The institution 104b notifies the business of the approval, or decline, whereby the transaction may proceed with the person.

In connection therewith, the processing network 102 is configured to coordinate with the institution 104a and the institution 104b to clear and settle the funds indicated by the transaction.

It should be understood that thousands, hundreds of thousands, or millions of such transactions occur in a given time interval between the institutions 104 a-d, through the processing network 102.

In addition to the above, in connection with issuing accounts, the institutions 104 a-d are configured to offer rewards for source accounts, whereby users earn rewards for transactions funded by the accounts issued by the institutions 104 a-d. The rewards may be in the form of miles, dollars, points, etc., and may be redeemable, in this example embodiment, for the purchase of travel from the travel provider 106 and, potentially, other travel providers (not shown). In the above example, the institution 104a may be configured to assign fifty (50) reward points to the person upon clearing and settlement of the transaction above.

In connection therewith, each user is not only associated with an account for funds to be debited from, credited to, etc. (depending on the type of account), but each user is also associated with a linked rewards account to which the rewards accumulate.

From time to time, thereafter, the users of the accounts may decide to redeem rewards for the purchase of travel from the travel provider 106. In this embodiment, for example, a user may select a flight from the travel provider 106, which departs from New York, NY USA on May 1, at 10:00 am and arrives in Baltimore, MD USA on May 1 at 11:15 am. That is, the user may browse different flights at a webpage associated with the travel provider 106, or associated with the institution 104a, and select to purchase the above flight (e.g., via a credit card (or payment account) provided to the user by the institution 104a, for instance, that offers a pay with rewards feature; etc.). As part of checkout, the user opts to redeem rewards, for example, as available and/or equivalent to the purchase price of the flight. In turn, the messaging associated with the payment transaction (e.g., an authorization message generated for the payment transaction by one of the institutions 104a-d associated with the travel provider 106, etc.) indicates the reward redemption as part of the payment for the flight (e.g., in a data element (DE) of the authorization message, etc.).

In various examples, in redeeming the rewards for the purchase of the price of the flight, the user may proceed with the payment transaction (e.g., via the user's payment/credit account, etc.) for the flight in a conventional manner (as generally described above) (e.g., between the institution 104a and the one of the institutions 104a-d associated with the travel provider 106, etc.). And then, following the payment transaction, a cashback action may be initiated for the payment transaction (e.g., by the processing network 102 upon identification of the reward redemption indication in the authorization message for the payment transaction, etc.), and a rebate may be deposited in the user's payment account (e.g., at the institution 104a, etc.) for an equivalent amount of the payment transaction (or an amount equal to the available rewards in the user's rewards account, for example, if the total available rewards is less than the purchase price of the flight). The cashback action may involve generation, for example, by the processing network 102, etc., of a rebate file and transmission of the rebated file to a clearing facility associated with the processing network 102 (e.g., the Global Clearing Management System (GCMS), etc.), whereby the appropriate funds may be deposited in the user's payment account, independent of any further authorization messages (e.g., the cashback action does not flow as an authorization message in the system 100, etc.).

In still other examples, in redeeming the rewards for the purchase of the price of the flight, the user again may proceed with the payment transaction (e.g., via the user's payment/credit account, etc.) for the flight in a conventional manner (as generally described above). And then, following the payment transaction, a vendor fulfillment file (VFF) may be generated, for example, by the processing network 102, and transmitted to the institution 104a (associated with the user's payment account) for transferring appropriate rewards points as airline miles to the travel provider 106 (e.g., the vendor from which or through which the user purchased the flight, etc.). Again, in these examples, the miles may be transferred independent of any further authorization message. What's more, in some instances, if the user just redeems points to earn airline miles, in these examples, there is no involvement of a cash transaction; the interaction is another redemption that is fulfilled by sending the VFF to the travel provider 106 (or other vendor, as appropriate).

As the messaging is passed through the processing network 102, the processing network 102 is configured to capture the reward redemption data, which indicates, in some examples, an amount, a number of points redeemed, a redemption category, an airline (or more broadly, a merchants and industry category and/or other related details), an issuer (e.g., the institution 104a, etc.) and the specific account issued by the issuer (e.g., the institution 104a, etc.), along with a time and date of the transaction. While the illustrated embodiment is specific to reward redemption data, it should be appreciated that any suitable payment account related data (whether related to rewards, purchases, etc.) may be used in other embodiments in a similar manner described below.

The processing network 102 is further configured to store the reward redemption data in the database 108. The processing network 102 is configured to repeat above many times, for reward redemptions, whereby the database includes reward redemption data for hundreds, thousands, or millions of transactions over various intervals.

As shown in FIG. 1, the system 100 also include a intelligence platform 110, which is included in whole or in part in the processing network 102. In connection therewith, the intelligence platform 110 is coupled in communication with the database 108, and is configured to access data included therein, including, specifically, the reward redemption data, and to compile metrics to be presented to travel providers, including, for example, the travel provider 106.

It should be appreciated that in various embodiments, the database 108 is configured to store additional data related to travel providers. For example, the database 108 may include various metrics such as, without limitation, available seat miles (ASM), cost per available seat mile (CASM), revenue per passage mile (RPM), load factors, yield, ancillary revenue per passenger, fuel efficiency, rout profitability, etc. The metrics may be retrieved from one or more sources, or compiled based on suitable, available data. In at least one embodiment, the metrics are downloaded as part of a data access agreement with another party (e.g., government agencies, industry associations, aviation data providers, financial analysts, etc.).

At the outset, the intelligence platform 110 is configured to identify a request or instruction for metrics, which defines the scope of the metrics. For example, the scope may be limited to a specific issuer (e.g., institution 104a, etc.); a specific type, brand, or class of account (e.g., Gold card from institution 104b, etc.); specific airlines; or any suitable combinations thereof.

In response, the intelligence platform 110 is initially configured to access the reward redemption data, which is specific to the scope of the metrics to be compiled (e.g., by airline, institution, account, etc.).

Next, the intelligence platform 110 is configured to calculate a reward redemption divisor (RRD) (broadly, a divisor) for the scope, as a summation of the rewards spent (or redeemed) for the airline, issuer, account, etc., according to one or more intervals (e.g., weekly, monthly, quarterly, annually, etc.). The RRD then is expressed as a vector, for example, with the sum of the rewards being the value, and the position indicative of the interval, etc., For instance, in one example, the RRD may be represented as a vector such as [Name of Airline, RRD metric value at different Time intervals] (e.g., [AA, 5500,6000,7000,8000], etc.). That said, as noted above, while this example is provided with regard to rewards redemption, it should be appreciated that in other embodiments the divisor may be calculated based on dollars spent or other financial data per one or more intervals.

It should be appreciated that the intelligence platform 110 may be configured to normalize the rewards to a common standard type. That is, when some rewards are expressed as miles or points, and others expressed as dollars, the intelligence platform 110 may be configured to convert miles to dollars, points to dollars, etc., or to another standard reward denomination.

Further, the intelligence platform 110 is configured to access one or more airline metrics, from the database 108, and to aggregate the one or more metrics with the RRD. One example RRD-based metric (broadly, divisor-based metric) is provided by the expression below:

$$Example Metric \#1 = \frac{AAS \times NM}{RRD} ,$$

where AAS is the available airlines seats for a given interval, NM is the number of miles that airline will be flying in the given interval, and RRD is the reward redemption divisor for that given interval.

It should be appreciated that various different RRD-based metrics may be generated in aggregation with the RRD in various different expressions to define such additional airline metrics. Additional example RRD-based metrics are discussed below. Each of the RRD-based metrics herein, again, is expressed in a time-series, in this example embodiment, where the interval is monthly, quarterly, annually, or some other suitable interval, etc.

Another example RRD-based metric is provided by the expression below, with regard to revenue per passenger miles (RPM):

$$Example Metric \#2 = \frac{NRP \times NM}{RRD} ,$$

Where NRP is the number of revenue passengers for a given interval (for an airline), NM is the number of miles that airline will be flying in the given interval, and RRD is the reward redemption divisor for that given interval. In this example, it is noted that the numerator (i.e., NRP×NM) may also be referred to as RPM. As such, in some examples, this metric may also be referenced as revenue passenger miles by reward redemption.

Another example RRD-based metric is provided by the expression below, relating to revenue per available seat mile (RASM):

$$Example Metric \#3 = \frac{( TOR / ASM )}{RRD} ,$$

where TOR is total operating revenue for an airline for a given interval, ASM is the number of available seat miles for the airline for the given interval, and RRD is the reward redemption divisor for that given interval. In this example, it is noted that the numerator (i.e., TOR/ASM) may also be referred to as RASM. As such, in some examples, this metric may also be referenced as RASM by reward redemption.

Another example RRD-based metric is provided by the expression below, relating to cost per available seat mile (CASM):

$$Example Metric \#4 = \frac{( TOC / ASM )}{RRD} ,$$

where TOC is total operating cost for an airline for a given interval, ASM is the number of available seat miles for the airline for the given interval, and RRD is the reward redemption divisor for that given interval. In this example, it is noted that the numerator (i.e., TOC/ASM) may also be referred to as CASM. As such, in some examples, this metric may also be referenced as CASM by reward redemption.

Another example RRD-based metric is provided by the expression below, relating to fuel efficiency:

$$Example Metric \#5 = \frac{( TFC / RPM )}{RRD} ,$$

where TFC is total fuel consumption (e.g., in gallons, etc.) for an airline for a given interval, RPM is the revenue passenger miles for the airline for the given interval, and RRD is the reward redemption divisor for that given interval. In this example, it is noted that the numerator (i.e., TFC/RPM) may also be referred to as fuel efficiency. As such, in some examples, this metric may also be referenced as fuel efficiency by reward redemption.

Based on the above, it should be appreciated that the RRD-based metrics define enhanced interpretation of certain data, which provides insight into the conventional metrics, relative to the RRD-based metric, and which informs the usage of rewards in connection therewith (in an enhanced manner, based on additional use of the RRD).

In this example embodiment, the RRD-based metrics are then exposed to generative artificial intelligence (AI), which is used to compile the above mentioned insights. In particular, the intelligence platform 110 is configured to provide the conventional airline metrics, along with the RRD-based metrics, to a generative AI model, such as, for example, the ChatGPT, etc. with the instruction to define actionable insights, statistical analyses and inferences, predictions, and suggestions with regard to any trends apparent to ChatGPT in the metrics with an objective of enhanced efficiencies, profitability, etc.

In one or more examples, the generative AI model may identify trends and/or insights, such as, for example, for ASM: “Customers using reward redemption make up 15% of Airline #1 Capacity by ASM in the last quarter. Other airlines average 18% over the same time frame.” Other trends, insights, and/or suggestions may include, without limitation, for revenue passenger miles: “Reward redemptions represent 8% of the total number of miles flown for Airline #1 in the last year, which reflects airline passenger traffic;” for airline yield: “It looks like the average fare paid by reward redemption is increasing over time on trips between Tokyo and Hong Kong. This is likely due to a positive impact of the recent promotion for 2× reward spend on institution's products;” for ancillary revenue per passenger: “It looks like consumers who used reward redemptions are less likely to generate revenue from non-ticketed sources such as baggage fees or inflight services. Perhaps we should target them with additional promotions;” and for rout profitability: “Redemption reward consumers make up 13% of consumers on your most profitable routes. Let's explore reward programs that have promotions for less profitable routes.”

It should be appreciated that the intelligence platform 110 may be configured to leverage generative AI in many different manners to gain the appropriate trends, insights, suggestions, etc., which are consistent with the RRD-based metrics.

Finally, the intelligence platform 110 is configured to present the insights, trends, suggestions, etc., to the travel provider 106, whereby the travel provider 106 may decide to make changes to offers (e.g., flight schedules, routes, etc.), promotions, incentives, etc., or to work with the processing network 102 and/or the institutions 104a-d to implement changes in rewards or available promotions, offers, etc., as applicable, at/to the travel provider 106. It should be appreciated that the insights, trends, suggestions, etc. may also be presented to one or more of the institutions 104a-d, whereby the institutions 104 a-d may seek changes in rewards offers, promotions, etc., based thereon.

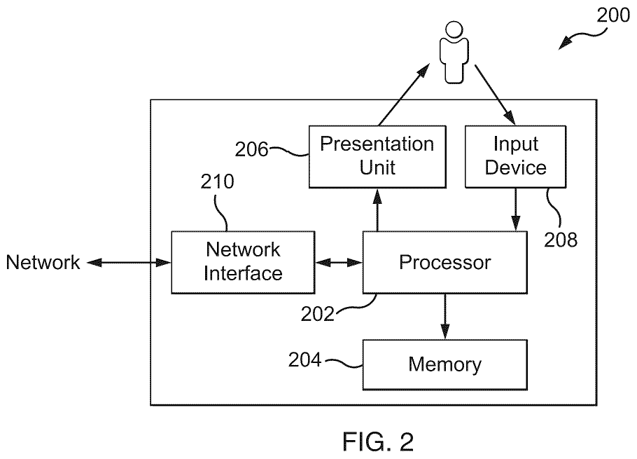

FIG. 2 illustrates an example computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the processing network 102, the institutions 104 a-d, the travel provider 106, the database 108 and the intelligence platform 110, for example, include or are included in, or integrated with, a computing device consistent with computing device 200. With that said, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to the processor 202. The processor 202 may include one or more processing units (e.g., in a multi-core configuration, etc.). For example, the processor 202 may include, without limitation, one or more processing units (e.g., in a multi-core configuration, etc.), including a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, metrics, reward redemption data, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is operating as described herein, whereby in performing such instructions the computing device 200 is transformed into a special-purpose computing device. It should be appreciated that the memory 204 may include a variety of different memories, each implemented in one or more of the functions or processes described herein.

In the example embodiment, the computing device 200 includes a presentation unit 206 that is coupled to the processor 202 (however, it should be appreciated that the computing device 200 could include output devices other than the presentation unit 206, etc.). The presentation unit 206 outputs information (e.g., insights, trends, suggestions, etc.), either visually or audibly to a user of the computing device 200, for example, a user associated with the travel provider 106, etc. It should be further appreciated that various interfaces (as described herein) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user (i.e., user input.) such as, for example, requests for insights, trends, suggestions, etc. The input device 208 is coupled to the processor 202 and may include, for example, a keyboard, a pointing device, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to the processor 202 and the memory 204. The network interface 210 may include, without limitation, a wired network adapter, a wireless network adapter, a mobile network adapter (e.g., an NFC adapter, a Bluetooth adapter, etc.), or other device capable of communicating to one or more different networks, including the network 110. Further, in some example embodiments, the computing device 200 may include the processor 202 and one or more network interfaces incorporated into or with the processor 202.

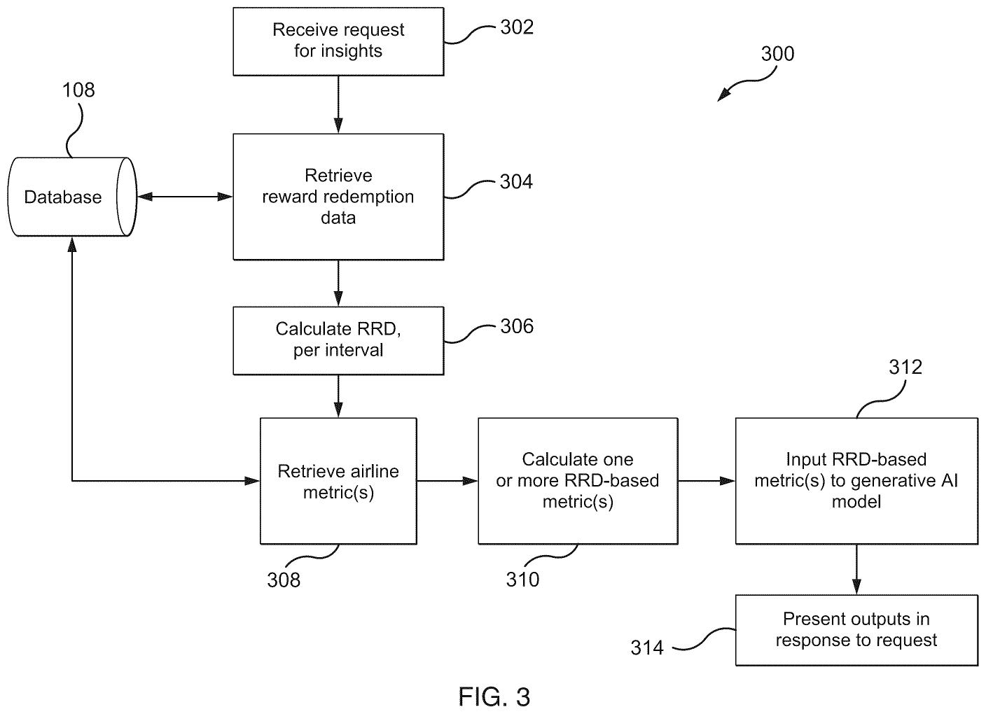

FIG. 3 illustrates an example method 300 for identifying enhanced interpretation of certain data. The example method 300 is described with reference to FIG. 1 as implemented in intelligence platform 110, and also with reference to the computing device 200. However, it should be understood that the methods herein are not limited to the example system 100 or the example computing device 200. Likewise, the systems and the computing devices herein should not be understood to be limited to the example method 300.

At the outset in the method 300, a request for insights, trends, etc., is generated by the processing network 102, travel provider 106, or potentially, one of the institutions 104a-d, and submitted to the intelligence platform 110. The request may include, for example, a scope, which defines an issuer (i.e., from the institutions 104a-d), a travel provider (e.g., airline such as travel provider 106, etc.), an account type (e.g., Platinum travel account, etc.), ranges of accounts (e.g., one or more accounts, etc.), separately or in combination, etc.

At 302, the intelligence platform 110 receives the request.

At 304, the intelligence platform 110 retrieves the reward redemption data from the database 108, relating to and/or pertinent to the request. The reward redemption data is limited by the scope included in the request, whereby the retrieved reward redemption data is limited to, for example, in this embodiment, to the travel provider 106 for the last three years. The travel provider 106, in this example is an airline. As such, the intelligence platform 110 retrieves reward redemption data for the airline for the last three years.

The intelligence platform 110 then calculates, as 306, the redemption reward divisor (RRD), per quarter, in this example (or other desired interval for the last three years, etc.). In doing so, the intelligence platform 110 segregates the reward redemption data into each of four quarters for the last three years, which provides twelve sets of reward redemption data. The intelligence platform 110 then converts, as necessary, the reward redemption data to a common or standard type of reward, such as, for example, pounds, dollars (USD), miles, kilometers, points, etc., and then aggregates, within each quarter, the rewards.

In this way, in this example, the intelligence platform 110 defines a twelve-value vector, where each value is a reward redemption divisor for a specific quarter over the last three years (thereby providing a vector for the airline (or travel provider 106) having twelve reward redemption divisor values).

At 308, the intelligence platform 110 retrieves applicable airline metrics (broadly, industry metrics) for the travel provider 106, such as, for example, ASM, CASM, RASM, RPM, fuel efficiency, etc., and calculates, at 310, one or more RRD-based metrics, which are based on the rewards redemption divisor and the one or more of the retrieved airline metrics. The one or more RRD-based metrics are broadly unique combinations of the conventional airline metrics and the reward redemption data (broadly, payment account related data), which is unique and instructive.

Next, the intelligence platform 110 inputs, at 312, the RRD-based metric(s) to one or more generative AI models, along with other data associated with the travel provider 106 (e.g., conventional airline metrics, revenues, etc.), and a request for one or more specific insights, trends, or suggestions to, for example, increase revenue, increase rewards redemption on certain routes, decrease rewards redemption for other routes, etc. The generative AI model is then enabled to identify specific trends, or insights, from the RRD-based metric(s) in combination with the other data, as applicable, and potentially, make one or more suggestions.

That said, it should be appreciated that the RRD-based metric(s) may be used independently of the one or more generative AI models in other example embodiments. In such examples, the RRD-based metrics may be used in combination with non-generative models, such as, for example, business intelligence tools, analytics tools, traditional AI/modeling tools, and other data engineering/ETL tools to manipulate the data and to analyze the trends, insights, suggestions, etc.

At 314, in this example, the intelligence platform 110 outputs the trends, insights, suggestions, etc., from the generative AI model, in response to the request, to, for instance, the travel provider 106. The travel provider 106 may then engage with the processing network 102 and/or one or more of the institutions 104a-d, to implement one or more suggestions, or to otherwise leverage the trends or insights revealed by the generative AI mode from the RRD-based metrics. In other examples, the intelligence platform 110 may output the trends, insights, suggestions, etc. to the processing network 102 whereby the processing network 102 may use the trends, insights, suggestions, etc. as part of market research to assist with business negotiations with customers (such as the travel provider 106, etc.). In either case, the trends, insights, suggestions, etc. may be displayed to internal or external customers via databases, cloud data storage, analytics tooling, websites or research/data publications, etc.

It should be appreciated that the generative AI model may be omitted in certain embodiments, whereby the intelligence platform 110 outputs the RRD-based metric(s) in response to the request to, for example, the travel provider 106 or one or more of the institutions 104a-d.

In view of the above, in example embodiments, the systems and methods herein rely on reward redemption data to provide for enhanced interpretation of certain data. In this way, the RRD-based metrics are created, which may aid travel providers and/or institutions and/or networks in optimizing operations, offerings, promotions, negotiations, etc., to improve profitability by accommodating how consumers use travel rewards in a cyclical, or non-cyclical manner.

Understanding how consumer redeem rewards provides valuable data on consumer preferences and behavior. Travel providers are enabled to use such metrics to tailor services and loyalty programs to better meet the needs and desires of consumers. By understanding how consumers use rewards, travel providers (e.g., airlines, etc.) are enabled to optimize loyalty programs to make the programs more attractive to consumers and increase consumer loyalty to the travel providers. The travel providers are also granted access to opportunities for revenue generation through add-ons, such as, for example, flight upgrades, additional in-flight services (e.g., Wi-fi, dining), and merchandise. Travel providers can also use this data to align with consumer preferences, encouraging more bookings and redemptions. This data can also be used to maximize their partnership and negotiate contracts with processing networks.

In addition, in example embodiments, the systems and methods herein may rely (more generally) on payment account related data (e.g., dollars spent, etc.) to provide for enhanced interpretation of certain data (via calculation of one or more divisors, etc.). In the same way, divisor-based metrics may be created, which may aid providers (e.g., merchants, etc.) and/or institutions and/or networks in optimizing operations, offerings, promotions, negotiations, etc., to improve profitability by accommodating how consumers spend, transact, etc. in a cyclical, or non-cyclical manner.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) in response to a request, retrieving, from a database, reward redemption data (broadly, payment account related data), the reward redemption data representative of redemption of rewards (broadly, payment account activity) for travel purchases (or other purchases) and limited to a scope, as defined in the request; (b) calculating a reward redemption divisor (RRD) (broadly, a divisor); (c) retrieving at least one industry metric; (d) calculating a RRD-based metric (broadly, a divisor-based metric), based on the RRD and the retrieved at least one industry metric; (c) presenting the RRD-based metric, in response to the request; (f) inputting the RRD-based metric and a request for a trend to a generative artificial intelligence (AI) model; (g) receiving a trend from the generative AI model; and/or (h) presenting the trend, along with the RRD-based metric, in response to the request.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” included with,” or “in communication with” another element or layer, it may be directly on, engaged, connected or coupled to, associated with, or in communication with the other element or layer, or intervening elements or layers may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements/features recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for identifying enhanced interpretation of certain data, the method comprising:
in response to a request, retrieving, by a computing device, from a database, reward redemption data, the reward redemption data representative of redemption of rewards for travel purchases and limited to a scope, as defined in the request;
calculating, by the computing device, a reward redemption divisor (RRD);
retrieving, by the computing device, at least one industry metric;
calculating, by the computing device, a RRD-based metric, based on the RRD and the retrieved at least one industry metric; and
presenting the RRD-based metric, in response to the request.

2. The computer-implemented method of claim 1, wherein the scope is defined by one of an airline, an institution, and an account type; and
wherein the reward redemption data identifies an airline involved in each of the travel purchases.

3. The computer-implemented method of claim 1, wherein calculating the RRD includes a summation of redeemed rewards included in the reward redemption data, consistent with the scope, within one or more intervals; and
wherein each interval is a month, a quarter of a year, or a year.

4. The computer-implement method of claim 3, wherein the scope includes an airline, whereby the reward redemption data is limited to the airline; and
wherein the at least one industry metric includes an available seat mile (ASM) or an available seat kilometer (ASK).

5. The computer-implement method of claim 1, further comprising:
inputting, by the computing device, the RRD-based metric and a request for a trend to a generative artificial intelligence (AI) model;
receiving a trend from the generative AI model; and
presenting the trend, along with the RRD-based metric, in response to the request.

6. The computer-implemented method of claim 5, wherein the RRD-based metric includes multiple RRD-based metrics.

7. A non-transitory computer-readable storage medium including executable instructions for use in identifying enhanced interpretation of certain data, which, when executed by at least one processor, cause the at least one processor to:
in response to a request, retrieve, from a database, payment account related data, the payment account related data representative of payment account activity and limited to a scope, as defined in the request;
calculate a divisor;
retrieve at least one industry metric;
calculate a divisor-based metric, based on the divisor and the retrieved at least one industry metric;
input the calculated divisor-based metric to an generative AI model; and
present an output, from the generative AI model, based on the divisor-based metric, in response to the request.

8. The non-transitory computer-readable storage medium of claim 7, wherein the scope is defined by one of an airline, an institution, and an account type; and
wherein the reward redemption data identifies an airline involved in each of the travel purchases.

9. The non-transitory computer-readable storage medium of claim 7, wherein the executable instructions, when executed by the at least one processor to calculate the divisor, cause the at least one processor to calculate a summation of payment account activity included in the payment account activity data, consistent with the scope, within one or more intervals; and
wherein each interval is a month, a quarter of a year, or a year.

10. The non-transitory computer-readable storage medium of claim 9, wherein the scope includes an airline and wherein the payment account activity data includes reward redemption data, whereby the reward redemption data is limited to the airline; and
wherein the at least one industry metric includes an available seat mile (ASM) or an available seat kilometer (ASK).

11. The non-transitory computer-readable storage medium of claim 7, wherein the executable instructions, when executed by the at least one processor, further cause the at least one processor to:
input the divisor-based metric and a request for a trend to a generative artificial intelligence (AI) model;
receive a trend from the generative AI model; and
present the trend, along with the divisor-based metric, in response to the request.

12. The non-transitory computer-readable storage medium of claim 11, wherein the divisor-based metric includes multiple divisor-based metrics.

13. A system for use in identifying enhanced interpretation of certain data, the system comprising at least one computing device configured to:
in response to a request, retrieve, from a database, reward redemption data, the reward redemption data representative of redemption of rewards for travel purchases and limited to a scope, as defined in the request;
calculate a reward redemption divisor (RRD);
retrieve at least one industry metric;
calculate a RRD-based metric, based on the RRD and the retrieved at least one industry metric;
input the calculated RRD-based metric to an generative AI model; and
present an output, from the generative AI model, based on the RRD-based metric, in response to the request.

14. The system of claim 13, wherein the scope is defined by one of an airline, an institution, and an account type; and
wherein the reward redemption data identifies an airline involved in each of the travel purchases.

15. The system of claim 13, wherein the at least one computing device is configured, in order to calculate the RRD, to calculate a summation of redeemed rewards included in the reward redemption data, consistent with the scope, within one or more intervals; and
wherein each interval is a month, a quarter of a year, or a year.

16. The system of claim 15, wherein the scope includes an airline, whereby the reward redemption data is limited to the airline; and
wherein the at least one industry metric includes an available seat mile (ASM) or an available seat kilometer (ASK).

17. The system of claim 13, wherein the at least one computing device is further configured to:
input the RRD-based metric and a request for a trend to a generative artificial intelligence (AI) model;
receive a trend from the generative AI model; and
present the trend, along with the RRD-based metric, in response to the request.

18. The system of claim 17, wherein the RRD-based metric includes multiple RRD-based metrics.
